(19) United States
(12) Patent Application Publication
(10) Pub. No.: US 2015/0046285 A1
(43) Pub. Date: Feb. 12, 2015

(54) METHOD AND SYSTEM FOR PROVIDING A LOTTERY TICKET USING A MOBILE PHONE

(71) Applicant: AMAYA GAMING GROUP INC., Pointe-Claire (CA)

(72) Inventor: David Baazov, Dollard-des-Ormeaux (CA)

(21) Appl. No.: 14/381,310

(22) PCT Filed: Feb. 28, 2013
(86) PCT No.: PCT/CA2013/000187

§ 371 Date: Aug. 27, 2014

Related U.S. Application Data
(60) Provisional application No. 61/604,053, filed on Feb. 28, 2012.

(51) Int. Cl. G06Q 50/34; G06Q 30/06; G06Q 20/32; G07F 17/32

(52) U.S. Cl. CPC G06Q 50/34; G07F 17/3225; G07F 17/329; G06Q 30/0607; G06Q 20/3255
USPC 705/26.25

(57) ABSTRACT

A method and a system are disclosed for providing a lottery ticket using a mobile phone, the method comprising receiving a ticket request sent by a user using the mobile phone, the ticket request comprising data associated with the lottery ticket and, if the user is allowed to purchase the lottery ticket, providing a lottery ticket comprising a first part and a second part, the first part for qualifying the user to an instant draw and the second part for qualifying the user to a scheduled draw wherein the scheduled draw is unrelated to the instant draw.

### CROSS-REFERENCE TO RELATED APPLICATIONS

This patent application claims priority of U.S. Patent Application No. 61/604,053 entitled “Method and System for Providing a Lottery Ticker” that was filed on Feb. 28, 2012, the specification of which is hereby incorporated by reference.

This patent application further claims priority on International Application No. PCT/CA2012/001090 entitled “System and Method for Performing a Wager Using a Mobile Phone” that was filed on Nov. 19, 2012, the specification of which is hereby incorporated by reference.

### FIELD

The invention relates to gaming. More precisely, this invention pertains to a method and system for providing a lottery ticket.

### BACKGROUND

Buying a lottery ticket using an SMS message is of great advantage because access to SMS is widely available.

While buying a lottery ticket using an SMS message may be simple for the user, the user may become frustrated at some point since he/she may have to repeat the lottery ticket ordering operation as many times as he/she wants to play.

There is a need for a method and a system that will overcome at least one of the above-identified drawbacks.

Features of the invention will be apparent from review of the disclosure, drawings and description of the invention below.

### BRIEF SUMMARY

According to a broad aspect, there is disclosed a method for providing a lottery ticket using a mobile phone, the method comprising receiving a ticket request sent by a user using the mobile phone, the ticket request comprising data associated with the lottery ticket; checking if the user is allowed to purchase the lottery ticket; and if the user is allowed to purchase the lottery ticket, providing a lottery ticket comprising a first part and a second part, the first part for qualifying the user to an instant draw and the second part for qualifying the user to a scheduled draw wherein the scheduled draw is unrelated to the instant draw.

According to one embodiment, the ticket request comprises an SMS message.

According to one embodiment, the data associated with the lottery ticket comprise a predetermined chain of characters indicative of the lottery game to play.

According to one embodiment, the method further comprises providing an instant feedback to the user, the instant feedback being associated to the instant draw.

According to one embodiment, the providing of an instant feedback to the user comprises sending an SMS message to the user, the SMS comprising an indication of an outcome for the instant draw.

According to another embodiment, the ticket request comprises a signal generated by an application running on the mobile phone.

According to one embodiment, the providing of the lottery ticket comprises displaying the lottery ticket in the application running on the mobile phone.

According to one embodiment, the providing of the lottery ticket comprises sending an email to an email address of the user of the mobile phone.

According to one embodiment, the method further comprises providing an instant feedback to the user, the instant feedback being associated to the instant draw.

According to another embodiment, the instant feedback is provided in the application used for sending the ticket request.

According to another embodiment, the instant feedback comprises at least one of a visual indication, a tactile feedback and an audio indication.

According to another embodiment, the checking to find out if the user is allowed to purchase the lottery ticket comprises obtaining an identification of a cell tower receiving the ticket request; checking if the user is registered and checking if the identification of the cell tower matches one of a list of allowed cell towers.

According to another embodiment, the obtaining of an identification of a cell tower receiving the ticket request comprises providing a phone number of the mobile phone sending the ticket request to a geolocalization server and obtaining from the geolocalization server latitude and longitude coordinates of the cell tower receiving the ticket request.

According to another embodiment, the user is not registered, the method further comprising inviting the user to register.

According to another embodiment, the checking if the user is registered comprises checking if a phone number of the mobile phone sending the request is located in a database of pre-registered users.

According to another broad aspect, there is disclosed a computer-readable storage medium for storing computer-executable instructions which when executed cause a computing device to perform a method for providing a lottery ticket using a mobile phone, the method comprising receiving a ticket request sent by a user using the mobile phone, the ticket request comprising data associated with the lottery ticket; checking if the user is allowed to purchase the lottery ticket; and if the user is allowed to purchase the lottery ticket, providing a lottery ticket comprising a first part and a second part, the first part for qualifying the user to an instant draw and the second part for qualifying the user to a scheduled draw wherein the scheduled draw is unrelated to the instant draw.

An advantage of the method disclosed is that it enables a user to play at least two different games, which is of great advantage for a user.

An advantage of the method disclosed is that two different gaming needs may be satisfied using a single ticket purchase, i.e., a first gaming need is a chance to gain an instant reward while a second gaming need is a chance to win a larger prize in a scheduled draw.

In one embodiment there are two chances, mutually exclusive, of winning the first game and the second game.

Another advantage of the method disclosed is that it may help increasing the revenues of the operator of the lottery system by selling more than one game in a single transaction.

### BRIEF DESCRIPTION OF THE DRAWINGS

In order that the invention may be readily understood, embodiments of the invention are illustrated by way of example in the accompanying drawings.

FIG. 1A is a flowchart which shows a first embodiment of a method for providing a lottery ticket using a mobile phone wherein a ticket request is received from a user.

FIG. 1B is a flowchart which shows a second embodiment of a method for providing a lottery ticket using a mobile phone wherein an SMS message is received from a user.

FIG. 1C is a flowchart which shows a third embodiment of a method for providing a lottery ticket using a mobile phone wherein a ticket request is generated by an application.

FIG. 2 is a block diagram which shows an example of a lottery ticket which may be obtained using an embodiment of the method disclosed herein.

FIG. 3 is a block diagram of an embodiment of a system for providing a lottery ticket using a mobile phone in the case where an SMS message is used.

FIG. 4 is a flowchart which shows an embodiment of a method for performing a wager using a mobile phone.

FIG. 5 is a flowchart which shows another embodiment of a method for performing a wager using a mobile phone.

Further details of the invention and its advantages will be apparent from the detailed description included below.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

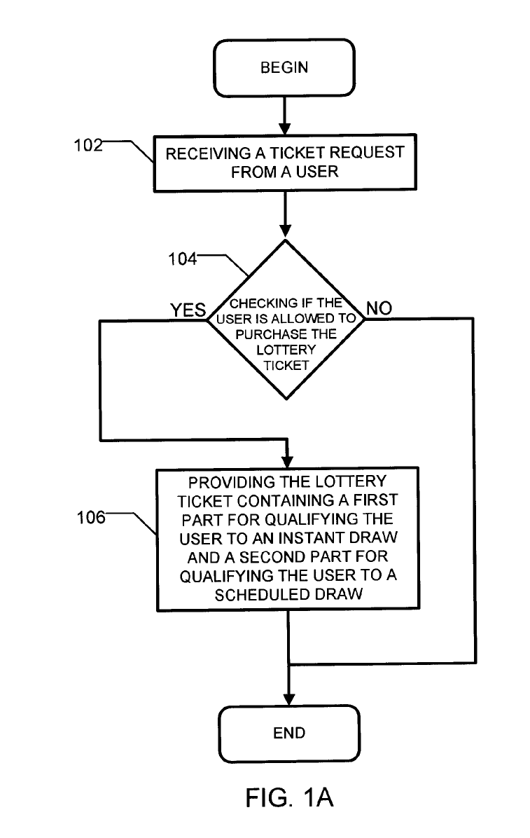

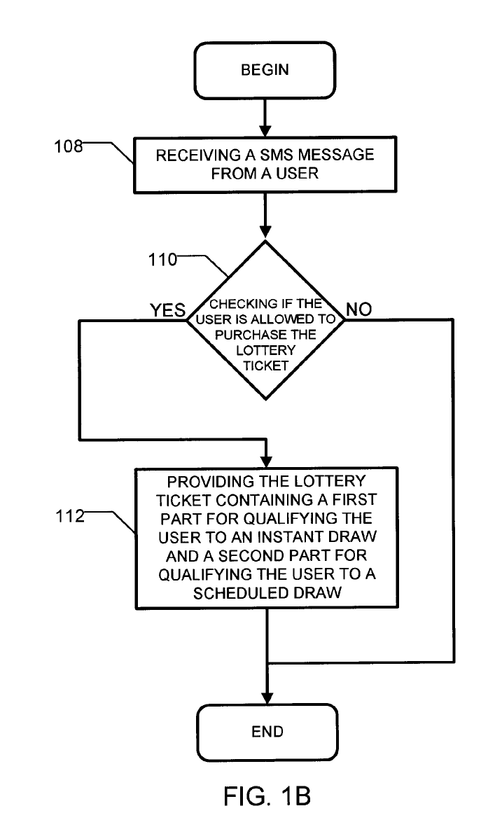

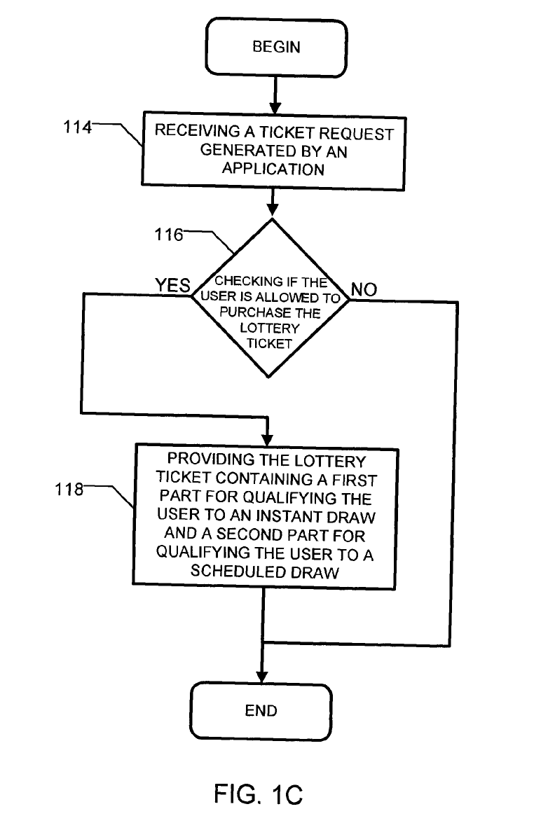

Now referring to FIG. 1A, there is shown a first embodiment of a method for providing a lottery ticket using a mobile phone.

According to processing step 102, a ticket request sent by a user using a mobile phone is received. The ticket request comprises data associated with the lottery ticket. It will be appreciated that the ticket request may be of various types.

According to processing step 104, a test is performed in order to find out if the user is allowed to purchase the lottery ticket.

It will be appreciated that the test may be performed according to various embodiments as further explained below.

In the case where the user is allowed to purchase the lottery ticket and in accordance with processing step 106, the lottery ticket is provided.

More precisely, the lottery ticket provided comprises a first part for qualifying the user to an instant draw and a second part for qualifying the user to a scheduled draw.

It will be appreciated that the lottery ticket is provided to the user.

Now referring to FIG. 1B, there is shown a second embodiment of a method for providing a lottery ticket using a mobile phone.

In this second embodiment, an SMS message is used for ordering the lottery ticket as further explained below.

More precisely, and according to processing step 108, an SMS message sent by a user using a mobile phone is received. The SMS message comprises data associated with the lottery ticket.

It will be appreciated that the data associated with the lottery ticket may be of various types since many types of lottery games may be provided.

In one embodiment, the data associated with the lottery ticket comprise a predetermined chain of characters indicative of the lottery game to play.

According to processing step 110, a test is performed in order to find out if the user is allowed to purchase the lottery ticket.

It will be appreciated that the test may be performed according to various embodiments.

In one embodiment, the test performed is disclosed in co-pending International Application No. PCT/CA2012/001090 entitled “System and Method for Performing a Wager Using a Mobile Phone” that was filed on Nov. 19, 2012, the specification of which is hereby enclosed by reference.

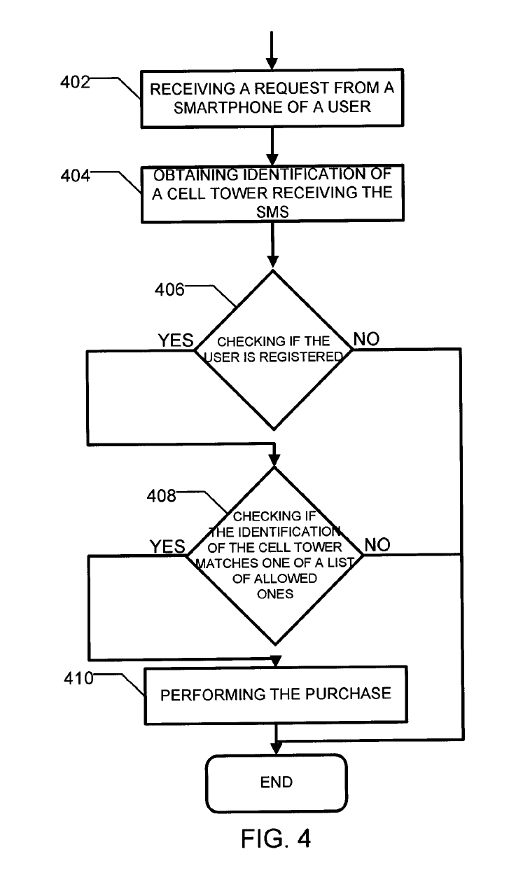

As shown in FIG. 4, there is illustrated an embodiment of a method for purchasing a ticket using a smartphone which shows how a test is performed in order to find out if the user is allowed to perform the purchase or not. The skilled addressee will appreciate that alternative embodiments may be used.

According to processing step 402, a request for performing a wager using a mobile phone is received.

It will be appreciated that the request for performing a wager may be provided according to various embodiments.

In one embodiment, the request for performing a wager is provided by an application running on the mobile phone. In another embodiment disclosed, the request comprises an SMS message provided by a user of the mobile phone.

It will be appreciated that the request may comprise various elements which depend on the application running on the mobile phone. In particular, the request may comprise an indication of a user handling the mobile phone and running the application.

The request may further comprise information related to the wager such as, for instance, the type of wager, the amount wagered and player information.

According to processing step 404, an identification of a cell tower receiving the request for performing a wager is obtained. It will be appreciated by the skilled addressee that the identification of a cell tower receiving the request for performing a wager may be obtained according to various embodiments.

In one embodiment, the identification of the cell tower is obtained using a geolocalization server. More precisely, a number of a phone number sending a request for performing a wager is provided in a request to the geolocalization server. In return, the geolocalization server provides latitude and longitude coordinates of the cell tower which received the request for performing a wager.

According to processing step 406, a check is performed in order to determine if the user is registered.

It will be appreciated that the check to find out if the user is registered is performed in one embodiment by using the phone number of the cell phone and checking it against a database of pre-registered users.

In fact, it will be appreciated that the pre-registering may be performed according to various embodiments. For instance, the pre-registering may be performed via a website by creating an account in which an authentication/validation is performed using at least one of a driver's license, a social security number, a passport, etc. The skilled addressee will appreciate that various alternative embodiments may be provided.

Alternatively, the pre-registering may be performed in the application running on the mobile phone and which provides the request for performing a wager.

The skilled addressee will therefore appreciate that the user may therefore be either registered beforehand or may register on the fly while performing the request.

Accordingly and in one embodiment, the user may be invited to register if the user is not registered.

The skilled addressee will appreciate that the purpose of performing the registration is to make sure the user is of legal age and consents to playing, an indication that the player has an amount of funds in its account sufficient for performing the wager.

In the case where the user is not registered, the purchase is not performed. It will be appreciated that the user may then be invited to register.

In the case where the user is registered and according to processing step 408, a check is performed in order to determine if the identification of the cell tower receiving the request for performing a wager matches one of a list of allowed cell towers.

It should be understood by the skilled addressee that processing step 408 may be alternatively performed prior processing step 406.

It will be appreciated that in one embodiment, the check is performed by ensuring that the latitude and longitude coordinates are not comprised in an uncertainty zone and are therefore acceptable.

In the case where the identification of the cell tower receiving the request for performing a wager matches one of a list of allowed cell towers and according to processing step 410, the purchase is performed.

In the case where the identification of the cell tower receiving the request for performing a wager matches one of a list of allowed cell towers, the purchase is performed.

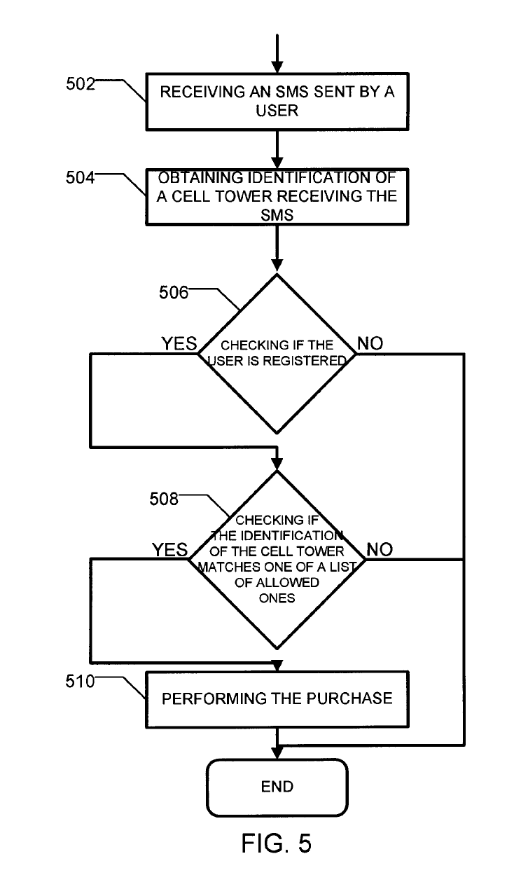

Now referring to FIG. 5, there is shown another embodiment of a method for performing a purchase of a lottery ticket using a mobile phone which illustrates how a check is performed to find out if a user is allowed to purchase a ticket in the case where a ticket is purchased using an SMS message sent by the user of the mobile phone. This may be used in the case where the mobile phone does not have the technical capabilities of running a gaming application.

According to processing step 502, an SMS message sent by a user using the mobile phone is received. The SMS message comprises data associated with the lottery ticket to purchase. It will be appreciated that the data associated with the lottery ticket to purchase may be of various types.

In one embodiment, the data associated with the lottery ticket to purchase comprises a given keyword. It will be appreciated that the given keyword is indicative of a lottery ticket to buy.

According to processing step 504, an identification of a cell tower receiving the SMS message is obtained. It will be appreciated by the skilled addressee that the identification of a cell tower receiving the SMS message may be obtained according to various embodiments.

In one embodiment, the identification of the cell tower is obtained using a geolocalization server. More precisely, a number of a phone number sending an SMS message is provided in a request to the geolocalization server. In return, the geolocalization server provides latitude and longitude coordinates of the cell tower which received the SMS message.

According to processing step 506, a check is performed in order to determine if the user is registered.

It will be appreciated that the check to find out if the user is registered is performed by using the phone number of the cell phone and checking it against a database of pre-registered users.

It will be appreciated that the pre-registering may be performed according to various embodiments. For instance, the pre-registering may be performed via a website by creating an account in which an authentication/validation is performed using at least one of a driver's license, a social security number, a passport, etc. The skilled addressee will appreciate that various alternative embodiments may be provided.

In the case where the user is not registered, the purchase is not performed. It will be appreciated that at this point the user may be invited to register.

In the case where the user is registered and according to processing step 508, a check is performed in order to determine if the identification of the cell tower receiving the SMS message matches one of a list of allowed cell towers.

It will be appreciated that in one embodiment, the check is performed by ensuring that the latitude and longitude coordinates are not comprised in an uncertainty zone and are therefore acceptable.

In the case where the identification of the cell tower receiving the SMS message matches one of a list of allowed cell towers and according to processing step 510, the purchase is performed.

In the case where the identification of the cell tower receiving the SMS message matches one of a list of allowed cell towers, the purchase is performed.

Now referring back to FIG. 1B and in the case where the user is allowed to purchase the lottery ticket and in accordance with processing step 112, a lottery ticket is provided.

More precisely, the lottery ticket provided comprises a first part for qualifying the user to an instant draw and a second part for qualifying the user to a scheduled draw. It will be appreciated that the scheduled draw is unrelated to the instant draw.

In one embodiment, the draw is created using Amaya™ software (Amaya™ SMS Client). The skilled addressee will appreciate that various alternative embodiments may be possible.

It will be appreciated that various types of information may be required in one embodiment in order to create a draw.

More precisely and in accordance with an embodiment, the information used for creating an instant draw comprises an indication of an instant draw name.

The information used for creating the instant draw further comprises an indication of a number of tickets available for purchase. The skilled addressee will appreciate that once all the tickets are sold, the instant draw will automatically close.

The information used for creating the instant draw further comprises a start date and a time period. The start date and the time period provide an indication of a start date and time of period during which tickets will be available for purchase.

The information used for creating the instant draw further comprises an end date and a corresponding time. The end date and the corresponding time provide an indication of until when tickets are available for purchase.

The information used for creating the instant draw further comprises an indication of a government permit ID and an obtained government permit date.

It will be appreciated that the information used for creating the instant draw further comprises a ticket price. It will be appreciated that the ticket price is used for reporting purposes only. The skilled addressee will appreciate that the ticket price does not affect the actual amount charged to players. In fact, it will be appreciated that the charge will be handled by an SMS aggregator in one embodiment.

More precisely, it will be appreciated that the system checks all the information used for creating the instant draw which is entered. If all the information is valid, the system creates the instant draw and the system generates tickets.

The following information is used to create the prize distribution categories one at a time.

More precisely, the information used for creating the prize distribution comprises an indication of a number of prizes, i.e. information related to a number of tickets that will have the payout.

The information used for creating the prize distribution further comprises an indication of a prize amount, i.e., a payout amount.

The information used for creating the prize distribution further comprises a description of the prize. It will be appreciated that the description of the prize may be a disburse (checked) or credit (unchecked). A disburse requires the player to call the call center to claim the winnings while a credit does not require any response from the player to receive winnings.

In the case where the information used for creating the prize distribution is valid, the system randomly determines the winning numbers. The instant lottery is created. The instant lottery becomes the active draw (open) and all purchases received from the SMS aggregator will result in a ticket from the active draw.

The skilled addressee will appreciate that the user may be provided with an instant feedback for the first part of the ticket related to the instant draw.

In one embodiment, the instant feedback comprises sending an SMS message to the user informing the user whether he/she has won the instant draw or not.

The SMS message may comprise a predefined chain of characters.

Some examples of data associated with the lottery ticket are provided below.

“Instant Lost Ticket 1234567890 ID 123456789012 is not a winner, Draw 12345. Keep ur ticket for chance to win on 05/05/11.”

“Instant Credit Prize to Phone U won 100000000.00MDL, Draw 12345, Ticket 1234567890 ID 123456789012. Account will be credited. Keep ur ticket for chance to win on 05/05/11.”

“Instant Prize Must be Claimed U won 100000000.00MDL, Draw 12345 Ticket 1234567890 ID 123456789012. Call 123456789 to claim. Keep ur ticket for chance to win on 05/05/11.”

As mentioned above, the second part of the ticket is used in one embodiment for qualifying the user to a scheduled draw.

In one embodiment the following information is used for creating a scheduled draw.

The information used for creating the scheduled draw comprises a name used for identifying the draw.

The information used for creating a scheduled draw further comprises an indication of a maximum number of tickets that may be purchased.

The information used for creating a scheduled draw further comprises a starting date and time which is a date and time during which tickets will be available for purchase.

The information used for creating a scheduled draw further comprises an end date and time which limits the period during which tickets will be available for purchase.

The information used for creating a scheduled draw further comprises an indication of a draw date and time which is the scheduled date and time for the draw. Since draws are external for self-pick, this value is only used to convey the information to customers.

The information used for creating a scheduled draw further comprises a government permit ID and a corresponding obtained government permit date.

The information used for creating a scheduled draw further comprises an indication of a ticket price for reporting purposes only. It will be appreciated that this does not affect the actual amount players will be charged. The charge is handled by the SMS aggregator in one embodiment.

In the case where prizes are awarded for correct last digits, “prizes for termination digits of the first prizes” options may be used.

Enabled: enables the prize of the corresponding prize category.

Prize Amount: select the payout amount.

Disburse (checked) or credit (unchecked): disburse requires the player to call a call center to claim the winnings. Credit requires no response from the player to receive winnings.

It will be appreciated that once all information is provided the system checks the information provided and the scheduled draw is created if all information is valid.

It will be appreciated that in one embodiment, the information used for creating the prize distribution comprises a place of prize. In one embodiment, the first prize is entered first before other main prizes such as second place and third place, if applicable.

The information used for creating the prize distribution further comprises a selected number of prizes, i.e., a selected number of tickets that will have a payout.

The information used for creating the prize distribution further comprises a selected payout amount.

The information used for creating the prize distribution further comprises a description of prize.

It will be appreciated that in one embodiment, prizes in a raffle are automatically set to disburse.

It will be further appreciated that when the system determines that the prize distribution is valid, the scheduled lottery is created and becomes the active draw (open). All purchases received from the SMS aggregator will result in a ticket from the active draw.

It will be appreciated that, if the scheduled draw occurs from an outside source, the result is then entered into the system. In fact, it will be appreciated that the result from the scheduled draw, i.e., the winning numbers, may be provided from a source outside the software such as for instance in a live draw. In such embodiment, the winning numbers may be entered manually.

It will be appreciated that in one embodiment, the scheduled draw must be closed in order to be able to enter the winning numbers. In fact, it will be appreciated that scheduled draws are automatically closed after the ending date/time elapses.

It will be appreciated that in one embodiment an operator may alert all winners after the winning numbers are entered.

Still in one embodiment, a notification will be sent for each winning ticket. In fact, it will be appreciated that in one embodiment only those with a winning ticket will receive a notification.

It will be appreciated that the alert may be provided according to various embodiments.

In one embodiment, a winner of multiple tickets will receive one notification per winning ticket.

As mentioned above, instant lottery winners may be alerted automatically and may not require an operator to alert them manually.

Now referring to FIG. 1C, there is shown a third embodiment of a method for providing a lottery ticket using a mobile phone.

According to processing step 114, a ticket request sent by a user using a mobile phone is received.

In this embodiment, the ticket request comprises a signal generated by an application running on the mobile phone. It will be appreciated that the application running on the mobile phone may be installed according to various embodiments.

The skilled addressee will appreciated that the signal may comprise a chain of characters in one embodiment.

According to processing step 116, a test is performed in order to find out if the user is allowed to purchase the lottery ticket.

It will be appreciated that the test may be performed according to various embodiments as explained above and described in FIGS. 4 and 5.

In the case where the user is allowed to purchase the lottery ticket and in accordance with processing step 118, a lottery ticket is provided.

More precisely, the lottery ticket provided comprises a first part for qualifying the user to an instant draw and a second part for qualifying the user to a scheduled draw.

It will be appreciated that the lottery ticket may be provided to the user according to various embodiments.

In one embodiment, the lottery ticket may be displayed in the application used for sending the ticket request.

Alternatively the lottery ticket may be provided using other means such as for instance by sending an email to an email address owned by the user.

As mentioned above, the ticket comprises a first part for qualifying the user to an instant draw and a second part for qualifying the user to a scheduled draw.

It will be appreciated that an instant feedback may be provided to the user for the instant draw. The instant feedback may be provided within the application used for sending the ticket request.

The instant feedback may be provided according to various embodiments.

For instance, the instant feedback may comprise at least one of a visual indication, a tactile feedback and an audio indication.

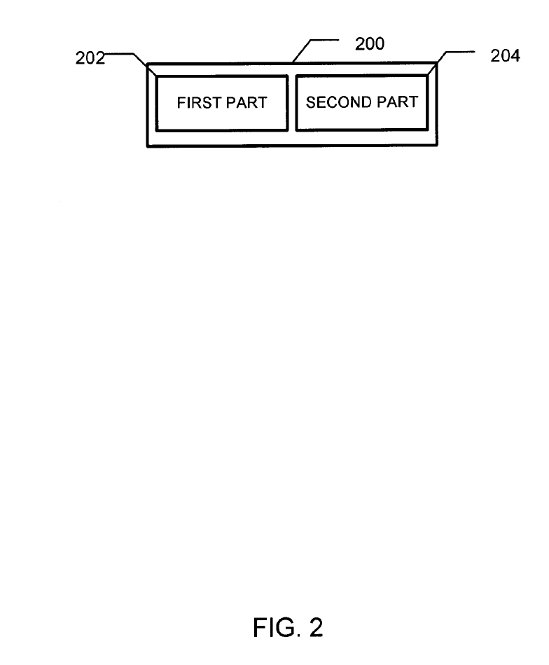

Now referring to FIG. 2, there is shown an embodiment of a lottery ticket 200.

The lottery ticket 200 comprises a first part 202 and a second part 204.

As mentioned above, the first part 202 is associated with an instant draw while the second part 204 is used for qualifying the user to a scheduled draw.

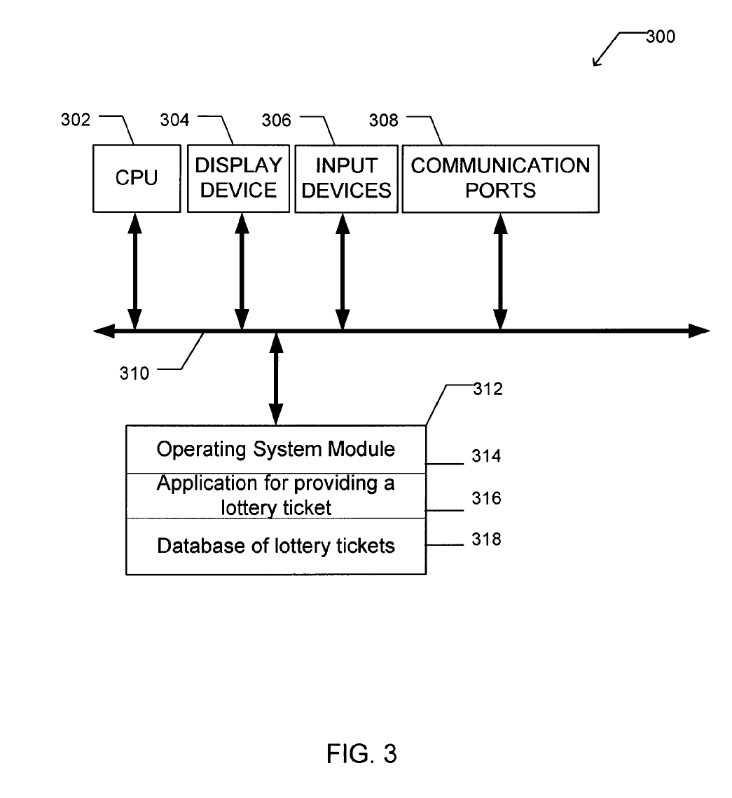

Now referring to FIG. 3, there is shown an embodiment of a system for providing a lottery ticket using a mobile phone. It will be appreciated that the system disclosed is used for providing a lottery ticket to a user sending an SMS message.

In this embodiment, the system 300 comprises a central processing unit (CPU) 302, a display device 304, input devices 306, communication ports 308, a data bus 310, and a memory 312.

It will be further appreciated that the display device 304 may be of various types.

In one embodiment, the input devices 306 comprise a keyboard and a mouse.

It will be appreciated that the communication ports 308 are used for communicating with a cellular network.

It will be appreciated that the CPU 302 may be of various types. In fact, it will be appreciated that the system for performing a purchase of a lottery ticket using a mobile phone disclosed herein is typically processing between 60-100 SMS messages per second. It will be appreciated by the skilled addressee that the specifications of the system for performing a purchase of a lottery ticket may vary greatly from the most basic computer to an advanced server depending on the size of the jurisdiction in which the system is deployed.

The memory 312 is used for storing data. More precisely and in one embodiment, the memory 312 comprises an operating system module 314, an application for providing a lottery ticket 316 and a database of lottery tickets.

In one embodiment, the operating system module 314 is provided by Microsoft™.

Still in one embodiment, the application for purchasing a lottery ticket 316 comprises instructions for receiving an SMS message sent by a user using the mobile phone, the SMS message comprising data associated with the lottery ticket.

The application for providing a lottery ticket 316 further comprises instructions for checking if the user is allowed to purchase the lottery ticket.

The application for providing a lottery ticket 316 further comprises instructions for providing a lottery ticket comprising a first part and a second part, if the user is allowed to purchase the lottery ticket, the first part for qualifying the user to an instant draw and the second part for qualifying the user to a scheduled draw wherein the scheduled draw is unrelated to the instant draw.

The database of lottery tickets 318 comprises a list of lottery tickets bought.

The CPU 302, the display device 304, the input devices 306, the communication ports 308 and the memory 312 are operatively interconnected via the data bus 310.

It will also be appreciated that a computer-readable storage medium may be provided for storing computer-executable instructions. Such computer-executable instructions, when executed, would cause a computing device to perform a method for providing a lottery ticket using a mobile phone, the method comprising receiving a ticket request sent by a user using the mobile phone, the ticket request comprising data associated with the lottery ticket; checking if the user is allowed to purchase the lottery ticket; and if the user is allowed to purchase the lottery ticket, providing a lottery ticket comprising a first part and a second part, the first part for qualifying the user to an instant draw and the second part for qualifying the user to a scheduled draw, wherein the scheduled draw is unrelated to the instant draw.

It will be appreciated by the skilled addressee that the fact the method disclosed entitles a user to play to at least two different games can be exciting for a user.

It will be further appreciated that the method disclosed herein may advantageously help to increase the revenues of a lottery operator.

Although the above description relates to a specific preferred embodiment as presently contemplated by the inventor, it will be understood that the invention in its broad aspect includes mechanical and functional equivalents of the elements described herein.

Clause 1: A method for providing a lottery ticket using a mobile phone, the method comprising:

receiving a ticket request sent by a user using the mobile phone, the ticket request comprising data associated with the lottery ticket;

checking if the user is allowed to purchase the lottery ticket; and

if the user is allowed to purchase the lottery ticket, providing a lottery ticket comprising a first part and a second part, the first part for qualifying the user to an instant draw and the second part for qualifying the user to a scheduled draw wherein the scheduled draw is unrelated to the instant draw.

Clause 2: The method as claimed in clause 1, wherein the ticket request comprises an SMS message.
Clause 3: The method as claimed in clause 2, wherein the data associated with the lottery ticket comprise a predetermined chain of characters indicative of the lottery game to play.
Clause 4: The method as claimed in any one of clauses 2 to 3, further comprising providing an instant feedback to the user, the instant feedback being associated to the instant draw.
Clause 5: The method as claimed in clause 4, wherein the providing of an instant feedback to the user comprises sending an SMS message to the user, the SMS comprising an indication of an outcome for the instant draw.
Clause 6: The method as claimed in clause 1, wherein the ticket request comprises a signal generated by an application running on the mobile phone.
Clause 7: The method as claimed in clause 6, wherein the providing of the lottery ticket comprises displaying the lottery ticket in the application running on the mobile phone.
Clause 8: The method as claimed in clause 6, wherein the providing of the lottery ticket comprises sending an email to an email address of the user of the mobile phone.
Clause 9: The method as claimed in any ones of clauses 6 to 8, further comprising providing an instant feedback to the user, the instant feedback being associated to the instant draw.
Clause 10: The method as claimed in any ones of clauses 6 to 9, wherein the instant feedback is provided in the application used for sending the ticket request.
Clause 11: The method as claimed in clause 10, wherein the instant feedback comprises at least one of a visual indication, a tactile feedback and an audio indication.
Clause 12: The method as claimed in any ones of clauses 1 to 11, wherein the checking to find out if the user is allowed to purchase the lottery ticket comprises obtaining an identification of a cell tower receiving the ticket request; checking if the user is registered and checking if the identification of the cell tower matches one of a list of allowed cell towers.
Clause 13: The method as claimed in clause 12, wherein the obtaining of an identification of a cell tower receiving the ticket request comprises providing a phone number of the mobile phone sending the ticket request to a geolocalization server and obtaining from the geolocalization server latitude and longitude coordinates of the cell tower receiving the ticket request.
Clause 14: The method as claimed in any ones of clauses 12 to 13, wherein the user is not registered, further comprising inviting the user to register.
Clause 15: The method as claimed in any ones of clauses 12 to 13, wherein the checking if the user is registered comprises checking if a phone number of the mobile phone sending the request is located in a database of pre-registered users.
Clause 16: A computer-readable storage medium for storing computer-executable instructions which, when executed, cause a computing device to perform a method for providing a lottery ticket using a mobile phone, the method comprising:

receiving a ticket request sent by a user using the mobile phone, the ticket request comprising data associated with the lottery ticket;

checking if the user is allowed to purchase the lottery ticket; and

if the user is allowed to purchase the lottery ticket, providing a lottery ticket comprising a first part and a second part, the first part for qualifying the user to an instant draw and the second part for qualifying the user to a scheduled draw, wherein the scheduled draw is unrelated to the instant draw.

1. A method for providing a lottery ticket using a mobile phone, the method comprising:
receiving a ticket request sent by a user using the mobile phone, the ticket request comprising data associated with the lottery ticket;
checking if the user is allowed to purchase the lottery ticket; and
if the user is allowed to purchase the lottery ticket, providing a lottery ticket comprising a first part and a second part, the first part for qualifying the user to an instant draw and the second part for qualifying the user to a scheduled draw, wherein the scheduled draw is unrelated to the instant draw.

2. The method as claimed in claim 1, wherein the ticket request comprises an SMS message.

3. The method as claimed in claim 2, wherein the data associated with the lottery ticket comprise a predetermined chain of characters indicative of the lottery game to play.

4. The method as claimed in claim 2, further comprising providing an instant feedback to the user, the instant feedback being associated to the instant draw.

5. The method as claimed in claim 4, wherein the providing of an instant feedback to the user comprises sending an SMS message to the user, the SMS comprising an indication of an outcome for the instant draw.

6. The method as claimed in claim 1, wherein the ticket request comprises a signal generated by an application running on the mobile phone.

7. The method as claimed in claim 6, wherein the providing of the lottery ticket comprises displaying the lottery ticket in the application running on the mobile phone.

8. The method as claimed in claim 6, wherein the providing of the lottery ticket comprises sending an email to an email address of the user of the mobile phone.

9. The method as claimed in claim 6, further comprising providing an instant feedback to the user, the instant feedback being associated to the instant draw.

10. The method as claimed in claim 6, wherein the instant feedback is provided in the application used for sending the ticket request.

11. The method as claimed in claim 10, wherein the instant feedback comprises at least one of a visual indication, a tactile feedback and an audio indication.

12. The method as claimed in claim 1, wherein the checking to find out if the user is allowed to purchase the lottery ticket comprises obtaining an identification of a cell tower receiving the ticket request; checking if the user is registered and checking if the identification of the cell tower matches one of a list of allowed cell towers.

13. The method as claimed in claim 12, wherein the obtaining of an identification of a cell tower receiving the ticket request comprises providing a phone number of the mobile phone sending the ticket request to a geolocalization server and obtaining from the geolocalization server latitude and longitude coordinates of the cell tower receiving the ticket request.

14. The method as claimed in claim 12, wherein the user is not registered, further comprising inviting the user to register.

15. The method as claimed in claim 12, wherein the checking if the user is registered comprises checking if a phone number of the mobile phone sending the request is located in a database of pre-registered users.

16. A computer-readable storage medium for storing computer-executable instructions which, when executed, cause a computing device to perform a method for providing a lottery ticket using a mobile phone, the method comprising:
receiving a ticket request sent by a user using the mobile phone, the ticket request comprising data associated with the lottery ticket;
checking if the user is allowed to purchase the lottery ticket; and
if the user is allowed to purchase the lottery ticket, providing a lottery ticket comprising a first part and a second part, the first part for qualifying the user to an instant draw and the second part for qualifying the user to a scheduled draw wherein the scheduled draw is unrelated to the instant draw.
